(19) United States
(12) Patent Application Publication
(10) Pub. No.: US 2007/0259834 A1
(43) Pub. Date: Nov. 8, 2007

(54) Dermally Applicable Liquid Formulations for Controlling Parasitic Arthropods on Animals

(75) Inventors: Kirkor Sirinyan, Gladbach (DE); Andreas Turberg, Haan (DE); Thomas Bach, Wuppertal (DE)

Correspondence Address: BAYER HEALTHCARE LLC, P.O.BOX 390, SHAWNEE MISSION, KS, 66201, US

(73) Assignee: BAYER HEALTH CARE AG, LEVERKUSEN (DE)

(21) Appl. No.: 11/587,480

(22) PCT Filed: Apr. 18, 2005
(86) PCT No.: PCT/EP05/04109

§ 371 Date: Jun. 25, 2007

(30) Foreign Application Priority Data
Apr. 28, 2004 (DE) 10 2004 020 721.6

(51) Int. Cl. A01N 65/00; A01N 25/02; A01P 7/02; A01P 7/04

(52) U.S. Cl. 514/68; 514/65

(57) ABSTRACT

The present invention relates to dermally applicable liquid formulations comprising synthetic or natural pyrethroids and halogen-free guanidines for controlling parasitic arthropods on animals.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The present invention relates to dermally applicable liquid formulations comprising synthetic or natural pyrethroids and halogen-free guanidines for controlling parasitic arthropods on animals.

The use of topical formulations comprising the active pyrethroid compound permethrin ((3-phenoxyphenyl)methyl 3-(2,2-dichloroethenyl)-2,2-dimethylcyclo-propanecarboxylate, CAS No. [52645-53-1]) for controlling parasitic arthropods on animals is known (cf., for example WO 95/17 090, JP-07 247 203, EP-A-567 368, EP-A-461 962, U.S. Pat. No. 5,236,954, U.S. Pat. No. 5,074,252 and WO 02/087 338).

Halogen-free guanidines for controlling parasitic insects are likewise known (see U.S. Pat. No. 5,434,181 and U.S. Pat. No. 5,532,365). These are preferably tetrahydro-3-furanylmethylamino derivatives of the general formula (I) 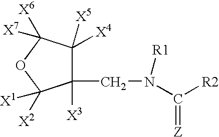
in which
X¹, X², X³, X⁴, X⁵, X⁶ and X⁷ each represent a hydrogen atom or an alkyl group having 1 to 4 carbon atoms,

R¹ represents a hydrogen atom, an alkyl group having 1 to 5 carbon atoms, an alkenyl group having 3 carbon atoms, a benzyl group, an alkoxyalkyl group having 2 to 4 carbon atoms (in the entire group), an alkoxycarbonyl group having 1 to 3 carbon atoms in its alkoxy moiety, a phenoxycarbonyl group, an alkylcarbonyl group having 1 to 6 carbon atoms in its alkyl moiety, an alkenylcarbonyl group having 2 to 3 carbon atoms in its alkenyl moiety, a benzoyl group substituted by 1 to 3 alkyl groups having 1 to 4 carbon atoms, a benzoyl group, substituted by 1 to 3 halogen atoms, a 2-furanylcarbonyl group or an N,N-dimethylcarbamoyl group;

R² represents a hydrogen atom, an amino group, a methyl group, an alkylamino group having 1 to 5 carbon atoms, a disubstituted alkylamino group having 2 to 5 carbon atoms (in the entire group), a 1-pyrrolidinyl group, an alkenylamino group having 3 carbon atoms, an alkynylamino group having 3 carbon atoms, a methoxyamino group, an alkoxyalkylamino group having 2 to 4 carbon atoms (in the entire group), a methylthio group or —N(Y¹)Y² (in which
Y¹ represents an alkoxycarbonyl group having 1 to 3 carbon atoms in its alkoxy moiety, a phenoxycarbonyl group, an alkylcarbonyl group having 1 to 6 carbon atoms in its alkyl moiety, an alkenylcarbonyl group having 2 to 3 carbon atoms in its alkenyl moiety, a cycloalkylcarbonyl group having 3 to 6 carbon atoms in its cycloalkyl moiety, a benzoyl group, a benzoyl group, substituted by 1 to 3 alkyl groups having 1 to 4 carbon atoms, a benzoyl group, substituted by 1 to 3 halogen atoms, a 2-furanylcarbonyl group, an N,N-dimethylcarbamoyl group, a (tetrahydro-3-furanyl)methyl group or a benzyl group and
Y² represents a hydrogen atom or an alkyl group having 1 to 5 carbon atoms); or
R¹ and R² together with the atoms to which they are attached may form a 5- to 7-membered saturated or unsaturated heterocycle which may contain 1 or 2 further identical or different heteroatoms or hetero groups selected from the group consisting of N-alkyl having 1 to 5 carbon atoms, NH, O, and S, and
Z represents ═N—NO₂, ═CH—NO₂, ═CH—CN or ═N—CN.

R¹ preferably represents a hydrogen atom or an alkyl group having 1 to 3 carbon atoms.

R² preferably represents an alkyl group having 1 to 3 carbon atoms, the amino group (NH₂), a monoalkylamino group having 1 to 3 carbon atoms in the alkyl moiety, a disubstituted alkylamino group having 2 to 5 carbon atoms (in the entire group).

If R¹ and R² together with the atoms to which they are attached form a heterocycle, this is preferably a saturated 5- or 6-membered heterocycle having a further 1 or 2 heteroatoms or hetero groups selected from the group consisting of N—CH₃, NH, O and S.

The moiety —NR¹—(C═Z)-R² of the compounds of the formula (I) may, for example, represent the following preferred radicals:

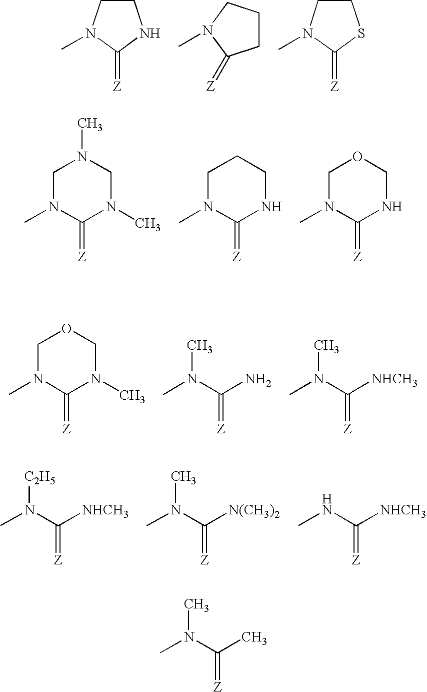

In the radicals listed above, Z represents ═N—NO₂, ═CH—NO₂, ═CH—CN or ═N—CN.

Preference is given to (tetrahydro-3-furanyl)methylamine derivatives of the formula (I) in which
X¹, X², X³, X⁴, X⁵, X⁶ and X⁷ each represent a hydrogen atom or an alkyl group having 1 to 4 carbon atoms;
R¹ represents a hydrogen atom, an alkyl group having 1 to 3 carbon atoms or an alkenyl group having 3 carbon atoms;
R² represents an alkylamino group having 1 to 3 carbon atoms or a dimethylamino group;
and Z represents ═CH—NO₂ or ═N—NO₂.

Preference is furthermore given to (tetrahydro-3-furanyl)methylamine derivatives of the formula (I) in which
X¹, X², X³, X⁴, X⁵, X⁶ and X⁷ each represent a hydrogen atom or
X¹, X², X³, X⁴, X⁶ and X⁷ each represent a hydrogen atom and X⁵ represents a methyl group or
X¹, X², X³, X⁴ and X⁵, each represent a hydrogen atom and X⁶ and X⁷ each represent a methyl group;
R¹ represents a hydrogen atom;
R² represents a methylamino group or a dimethylamino group; and
Z represents ═CH—NO₂ or ═N—NO₂.

Preference is furthermore given to (tetrahydro-3-furanyl)methylamine derivatives of the formula (I) in which
X¹, X², X³, X⁴, X⁵, X⁶ and X⁷ represent a methyl group;
R¹ represents a hydrogen atom;
R² represents a methylamino group; and
Z represents ═CH—NO₂.

Preference is furthermore given to (tetrahydro-3-furanyl)methylamine derivatives of the formula (I) in which
X¹, X², X³, X⁴, X⁵, X⁶ and X⁷ each represent a hydrogen atom or
X¹, X², X³, X⁴, X⁵ and X⁶ each represent a hydrogen atom and X⁷ represents a methyl group;
R¹ represents a hydrogen atom;
R² represents a methylamino group; and
Z represents ═N—NO₂.

Preference is further given to (tetrahydro-3-furanyl)methylamine derivatives of the formula (I) in which X¹, X², X³, X⁴, X⁵, X⁶ and X⁷ each represent a hydrogen atom or
X¹, X², X³, X⁴, X⁵ and X⁶ each represent a hydrogen atom and X⁷ represents a methyl group;
R¹ and Y¹ each represent an alkoxycarbonyl group having 1 to 3 carbon atoms in its alkoxy moiety, an alkylcarbonyl group having 1 to 6 carbon atoms in its alkyl moiety, an alkenylcarbonyl group having 2 to 3 carbon atoms in its alkenyl moiety, a cycloalkylcarbonyl group having 3 to 6 carbon atoms in its cycloalkyl moiety, a benzoyl group, a benzoyl group substituted by 1 to 3 alkyl groups having 1 to 4 carbon atoms, a benzoyl group substituted by 1 to 3 halogen atoms, a 2-furanylcarbonyl group or an N,N-dimethylcarbamoyl group,
Y² represents a methyl group, and
Z represents ═N—NO₂.

Preference is furthermore given to (tetrahydro-3-furanyl)methylamine derivatives of the formula (I) in which
X¹, X², X³, X⁴, X⁵, X⁶ and X⁷ each represent a hydrogen atom or
X¹, X², X³, X⁴, X⁵ and X⁶ each represent a hydrogen atom and X⁷ represents a methyl group;
R¹ and Y¹ each represent an alkylcarbonyl group having 1 to 4 carbon atoms in its alkyl moiety or a cyclopropylcarbonyl group and Y² represents a methyl group; and
Z represents ═N—NO₂.

Preference is furthermore given to (tetrahydro-3-furanyl)methylamine derivatives of the formula (I) in which
X¹, X², X³, X⁴, X⁵, X⁶ and X⁷ each represent a hydrogen atom or
X¹, X², X³, X⁴, X⁵ and X⁶ each represent a hydrogen atom and X⁷ represents a methyl group;
R¹ represents an alkylcarbonyl group having 1 to 4 carbon atoms in its alkyl moiety; R² represents a dimethylamino group; and
Z represents ═N—NO₂.

According to the invention, particularly preferred examples of these compounds are: 1-[(tetrahydro-3-furanyl)methyl]-2-nitro-3-methylguanidine (dinotefuran) and 1-[(tetrahydro-3-furanyl)methyl]-1,2-dicyclohexylcarbonyl-2-methyl-3-nitroguanidine.

Suitable active pyrethroid compounds which may be emphasized are the pyrethrins and pyrethroids, for example those having common names such as fenvalerate [α-cyano-3-phenoxybenzyl α-(p-Cl-phenyl)isovalerate], flumethrin α-cyano-4-fluoro-3-phenoxy)benzyl [3-[2-(4-chlorophenyl)-2-chlorovinyl]-2,2-dimethylcyclopropanecarboxylate] and its enantiomers and stereoisomers, cyfluthrin [(α-cyano-4-fluoro-3-phenoxy)benzyl 2,2-dimethyl-3-(2,2-dichlorovinyl)cyclopropanecarboxylate], permethrin [3-phenoxybenzyl cis,trans-3-(2,2-dichlorovinyl)-2,2-dimethylcyclopropanecarboxylate], cypermethrin [α-cyano-3-phenoxybenzyl 2,2-dimethyl-3-(2,2-dichlorovinyl)cyclopropanecarboxylate], cyphenothrin [α-cyano-m-phenoxybenzyl 2,2-dimethyl-3-(2-methylpropenyl)cyclopropanecarboxylate], deltamethrin [α-cyano-3-phenoxybenzyl cis,trans-3-(2,2-dibromovinyl)-2,2-dimethylcyclopropanecarboxylate], fluvalinate [2-cyano-3-phenoxybenzyl 2-(2-chloro-α,α,α-trifluoro-p-toluido)-3-methylbutyrate]. Pyrethroids having acaricidal action are preferred for preparing the novel formulations; α-cyanopyrethroids and alcohols or esters derived therefrom, such as esters of α-cyano-3-phenylbenzyl alcohols or 4-fluoro-α-cyano-3-phenoxybenzyl alcohols are particularly preferred. Very particularly preferred active compounds according to the invention are permethrin and flumethrin.

However, representatives of the non-ester pyrethroids, such as, for example, etofenprox or silafluofen, or natural pyrethrins in the form of Pyrethrum extract may also be used as further compounds from the group of the pyrethroids. From among these, particular preference is given to etofenprox.

As is known, the disadvantage of formulations comprising only a pyrethroid as sole active compound is the low activity against fleas.

In general, spot-on formulations based on halogen-free guanidines are highly effective against fleas when used at relatively high application rates (>15 mg of active compound/kg of body weight). However, they have the disadvantage that they are ineffective against ticks.

The prior-art combination formulations comprising active pyrethroid compounds and agonists or antagonists of the nicotinic acetylcholine receptors have disadvantages with respect to the control of parasites on animals, in particular pets (for example dogs, cats). They require the use of relatively large amounts of active compound and/or, in many cases, cause skin irritations. Synthetic pyrethroids, such as, for example, permethrin, flumethrin or deltamethrin, are strongly aprotic compounds, whereas agonists and antagonists of the nicotinic acetylcholine receptors, in particular dinotefuran analogues, are protic compounds. Accordingly, it is not easy to provide a dermally applicable liquid formulation which comprises both active compounds and has the following properties:
well tolerated by target animal and user
low homeotherm toxicity
environmentally friendly
excellent efficacy against fleas and ticks for a duration of up to four weeks.

Accordingly, it was an object of the present invention to provide a skin- and environmentally friendly, user friendly formulation for dermal application effective against parasitic arthropods, in particular ticks and fleas, which formulation comprises an active pyrethroid compound and halogen-free agonists or antagonists of the nicotinic acetylcholine receptors of insects.

This object is achieved by the compositions according to the invention described below.

The present invention relates to
1. Compositions comprising
   a) 0.1-60% by weight of an active pyrethroid compound
   b) 7.5-30.0% by weight of dinotefuran and/or dinotefuran analogues
   c) 27.5-62.5% by weight of organic solvents from the class of the methylpyrrolidones, aliphatic alcohols and cyclic carbonates, aliphatic, cyclic or acyclic ethers and mixtures of these
   d) 0-5% by weight of water
   e) 0-0.5% by weight of phenolic antioxidants and
   f) 0-0.5% by weight of organic acids.

The stated percentages by weight are based on the total weight.

“Dinotefuran and/or dinotefuran analogues” are to be understood here as meaning, in particular, the compounds of the formula (I) described above.

“Active pyrethroid compounds” are in particular the compounds mentioned under this term above.

In a preferred embodiment, the compositions according to the invention additionally comprise:
2.0-10% by weight of fatty acid esters or glycerides as spreading agents or as agents for improving skin- and eye-friendliness.

The compositions according to the invention are usually liquid and suitable for dermal application, in particular as pour-on or spot-on formulations.

Very particularly preferred pyrethroids are permethrin and flumethrin.

The preferred amount of flumethrin applied is in the range from 0.2 to 1.0% by weight.

The amounts of permethrin in the composition according to the invention can be varied within wide limits between 35-60% by weight. Preference is given to amounts in the range of 45-60% by weight; with particular preference, the composition according to the invention comprises permethrin in the range of 47.5-55% by weight.

To prepare the liquid formulations according to the invention, it is possible to use all customary isomer mixtures of the active permethrin compound. The preferred isomer mixture comprises 35-45% by weight of cis- and 55-65% by weight of trans-permethrin. The particularly preferred isomer mixture comprises 37.5-42.5% by weight of cis- and 57.5-62.5% by weight of trans-permethrin.

The amounts of dinotefuran or dinotefuran analogue can also be varied within wide limits between 7.5 and 30% by weight, amounts in the range of 10.0-25.0% by weight being preferred. With particular preference, dinotefuran or the dinotefuran analogue is employed in the compositions according to the invention in amounts in the range of 12.5-20% by weight.

Said formulations may, of course, also comprise further suitable active compounds.

Examples which may be mentioned are growth-inhibiting active compounds and synergists, such as, for example, pyriproxyfen {2-[1-methyl-2-(4-phenoxyphenoxy)-ethoxy]pyridine CAS No.: 95737-68-1}, methoprene [(E,E)-1-methylethyl 11-methoxy-3,7,11-trimethyl-2,4-dodecadienoate CAS No.: 40596-69-8] and triflumuron {2-chloro-N-[[[4-(trifluoromethoxy)phenyl]amino]carbonyl]benzamide CAS No.: 64628-44-0}.

The amounts of antioxidant may be varied broadly in the range of 0-0.5% by weight, where preference is given to amounts in the range of 0.05-0.25% by weight. With particular preference, amounts in the range of 0.05-0.15% by weight are used for preparing the compositions according to the invention. All customary antioxidants are suitable, preferably phenolic antioxidants, such as, for example, butylated hydroxytoluene, butylated hydroxyanisole, tocopherol.

The amount of organic acid may be varied broadly in the range of 0-0.5% by weight, where preference is given to amounts in the range of 0.05-0.25% by weight. With particular preference, amounts in the range of 0.05-0.15% by weight are used for preparing the compositions according to the invention. Suitable for use in the compositions according to the invention are all pharmaceutically acceptable organic acids, in particular carboxylic acids, such as, for example, citric acid, tartaric acid, lactic acid, succinic acid, and malic acid. Particular preference is given to the organic acids citric acid and malic acid. Very particular preference is given to citric acid. Their amount can be varied broadly, in particular in the range of 0.05 to 0.25% by weight, where particular preference is given to amounts in the range of 0.075-0.15% by weight.

The amounts of di- or triglyceride may be varied broadly in the range of 2.5-10% by weight, where preference is given to amounts in the range of 2.0-10% by weight. With particular preference, amounts in the range of 2.5-7.5% by weight are used in the compositions according to the invention.

Preferred solvents are organic solvents having a boiling point>80° C. and a flash point>75° C. The solvents preferably have a spreading action. In this context, reference may be made to relatively high-boiling aromatic alcohols, such as benzyl alcohol, N-methylpyrrolidone, 2-pyrrolidone, n-octylpyrrolidone, aromatic esters, such as benzyl acetate, benzyl benzoate, cyclic and/or acyclic carbonates, such as propylene carbonate or ethylene carbonate. Suitable for use in the compositions according to the invention are ethers or polyethers, for example from the group consisting of diethylene glycol monoethyl ether, dipropylene glycol monomethyl ether, tetrahydrofurfuryl alcohol and tetrahydrofurfuryl ethoxylate, where the two last-mentioned compounds are particularly preferred.

However, to prepare the compositions according to the invention, preference is given to using N-methylpyrrolidone, benzyl alcohol, tetrahydrofurfuryl alcohol and their mixtures.

The spreading agents used are in particular fatty acid esters and triglycerides.

Fatty acid esters and triglycerides which may be mentioned are, for example: isopropyl myristate, Miglyol 810, Miglyol 812, Miglyol 818, Miglyol 829, Miglyol 840 and Miglyol 8810 (for the definition of the miglyols see, for example, H. P. Fiedler Lexikon der Hilfsstoffe für Pharmazie, Kosmetik und angrenzende Gebiete [Encyclopaedia of Auxiliaries for Pharmacy, Cosmetics and related fields], pages 1008-1009, Vol. 2, publisher Cantor Verlag Aulendorf (1996)).

From the experiments carried out so far, it can be seen that the mixtures according to the invention modified with the solvents and auxiliaries mentioned are distinguished by their better skin- and eye-friendliness, better biological activity and by their more favourable stability properties under cold conditions in the customary single-dose application tubes.

In addition to the components listed above, the compositions according to the invention may comprise further pharmaceutically acceptable auxiliaries. Auxiliaries which may be mentioned are, for example: spreaders and surfactants.

Spreaders are, for example, spreading oils, such as di-2-ethylhexyl adipate, isopropyl myristate, dipropylene glycol pelargonate, cyclic and acyclic silicone oils, such as dimethicone, and further co- and terpolymers thereof with ethylene oxide, propylene oxide and formaldehyde, fatty acid esters, triglycerides, fatty alcohols.

To optimize the spreading properties, said formulations may be modified in a manner known per se with surfactants.

Surfactants which may be mentioned are: nonionic surfactants, for example polyethoxylated castor oil, polyethoxylated sorbitan monooleate, sorbitan monostearate, -glycerol monostearate, polyoxyethyl stearate, alkylphenol polyglycol ethers; ampholytic surfactants, such as di-Na N-lauryl-β-iminodipropionate or lecithin; anionic surfactants, such as Na lauryl sulphate, fatty alcohol ether sulphates, mono/dialkyl polyglycol ether orthophosphoric acid ester monoethanolamine salt; cationic surfactants, such as cetyltrimethylammonium chloride.

The compositions according to the invention can be prepared by customary processes, for example by mixing the active compounds with stirring with the other components and preparing a solution. The solution may, if appropriate, be filtered. Suitable containers are, for example, plastic tubes.

Surprisingly, the ectoparasiticidal activity of the compositions according to the invention comprising pyrethroids in combination with dinotefuran or a dinotefuran analogue is higher than would have been expected from the activities of the individual components. By using these compositions, it is therefore possible to reduce the application rates of active compound and to increase long-term action. As a result, their use has economic and ecological advantages.

The compositions according to the invention are highly suitable for use in controlling parasites.

Parasites which may be mentioned are:
from the order of the Anoplura, for example, Haematopinus spp., Linognathus spp., Solenopotes spp., Pediculus spp., Pthirus spp.;
from the order of the Mallophaga for example Trimenopon spp., Menopon spp., Eomenacanthus spp., Menacanthus spp., Trichodectes spp., Felicola spp., Damalinea spp., Bovicola spp;
from the order of the Diptera, for example, Aedes spp., Culex spp., Simulium spp., Phlebotomus spp., Chrysops spp., Tabanus spp., Musca spp., Hydrotaea spp., Muscina spp., Haematobosca spp., Haematobia spp., Stomoxys spp., Fannia spp., Glossina spp., Lucilia spp., Calliphora spp., Auchmeromyia spp., Cordylobia spp., Cochliomyia spp., Chrysomyia spp., Sarcophaga spp., Wohlfartia spp., Gasterophilus spp., Oesteromyia spp., Oedemagena spp., Hypoderma spp., Oestrus spp., Rhinoestrus spp., Melophagus spp., Hippobosca spp.
from the order of the Siphonaptera, for example, Ctenocephalides spp., Echidnophaga spp., Ceratophyllus spp., Pulex spp.
from the order of the Metastigmata, for example, Hyalomma spp., Rhipicephalus spp., Boophilus spp., Amblyomma spp., Haemaphysalis spp., Dermacentor spp., Ixodes spp., Argas spp., Ornithodorus spp., Otobius spp.;
from the order of the Mesostigmata, for example, Dermanyssus spp., Ornithonyssus spp., Pneumonyssus spp.
from the order of the Prostigmata, for example, Cheyletiella spp., Psorergates spp., Myobia spp., Demodex spp., Neotrombicula spp.;
from the order of the Astigmata, for example, Acarus spp., Myocoptes spp., Psoroptes spp., Chorioptes spp., Otodectes spp., Sarcoptes spp., Notoedres spp., Knemidocoptes spp., Neoknemidocoptes spp. Cytodites spp., Laminosioptes spp.

The compositions according to the invention are particularly suitable for controlling ectoparasites, usually arthropods, for example insects or arachnids (such as mites or ticks), preferably ticks and/or fleas, on animals, in particular warm-blooded animals, especially mammals. The compositions according to the invention are preferably used for pets. Here, pets are to be understood as including, in particular, dogs, cats and other warm-blooded animals of a size not greater than that of a dog; i.e. they have a body weight of generally not more than 90 kg, preferably not more than 50 kg. The compositions according to the invention are particularly preferably used for dogs and cats, in particular for dogs.

Since the treated animals generally also spread a certain amount of the composition used in the surroundings, for example by scratching or with debris, the compositions according to the invention may act not only directly on the animal but, correspondingly, also in their surroundings.

The liquid formulations according to the invention are distinguished by their excellent storage stability of at least three years in all climate zones. By virtue of its excellent activity, the application volume may be kept small. Preferred application volumes are 0.1-0.35 ml/1.0 kg [body weight of the animal to be treated], preferably 0.15-0.25 ml/1.0 kg [body weight of the animal to be treated].

They are highly suitable for being filled into and sold in storage-critical containers, such as, for example, “single dose polypropylene plastic tubes” of a wall thickness of 300-500 μm and a filling volume of 1.0 to 10.0 ml.

Furthermore, the compositions according to the invention have excellent skin friendliness and low toxicity.

Finally, by virtue of their biological degradability, they are environmentally friendly.

### EXAMPLES

### Example 1

A homogeneous spot-on solution comprising

| | |
|---|---|
| 45 g | of permethrin comprising 40% cis- and 60% trans-isomers |
| 24 g | of dinotefuran |
| 130.8 g | of N-methylpyrrolidone |
| 0.1 g | of citric acid |
| 0.1 g | of BHT (butylated hydroxytoluene) |

### Example 2

A homogeneous spot-on solution comprising

| | |
|---|---|
| 45 g | of permethrin comprising 40% cis- and 60% trans-isomers |
| 25 g | of dinotefuran |
| 119.8 g | of N-methylpyrrolidone |
| 5.0 g | of water |
| 0.1 g | of citric acid |
| 0.1 g | of BHT |

### Example 3

A homogeneous spot-on solution comprising

| | |
|---|---|
| 45 g | of permethrin comprising 40% cis- and 60% trans-isomers |
| 20 g | of dinotefuran |
| 124.8 g | of benzyl alcohol |
| 10.0 g | of water |
| 0.1 g | of citric acid |
| 0.1 g | of BHT |

### Example 4

| | |
|---|---|
| 45 g | of permethrin comprising 40% cis- and 60% trans-isomers |
| 20.0 g | of dinotefuran |
| 119.8 g | of benzyl alcohol/tetrahydrofuran (mixing ratio 1:1) |
| 0.1 g | of lactic acid |
| 0.1 g | of BHT |

### Example 5

A homogeneous spot-on solution comprising

| | |
|---|---|
| 45 g | of permethrin comprising 40% cis- and 60% trans-isomers |
| 20 g | of dinotefuran |
| 124.8 g | of N-methylpyrrolidone |
| 0.1 g | of citric acid |
| 0.1 g | of BHT (butylated hydroxytoluene) |
| 10.0 g | of Miglyol 812 from Sasol Germany GmbH, D-58453 Witten |

### Example 6

A homogeneous spot-on solution comprising

| | |
|---|---|
| 45 g | of permethrin comprising 40% cis- and 60% trans-isomers |
| 25 g | of dinotefuran |
| 114.8 g | of N-methylpyrrolidone |
| 5.0 g | of water |
| 0.1 g | of citric acid |
| 0.1 g | of BHT |
| 10.0 g | of Miglyol 840 from Sasol Germany GmbH, D-58453 Witten |

### Example 7

A homogeneous spot-on solution comprising

| | |
|---|---|
| 50.0 g | of permethrin comprising 40% cis- and 60% trans-isomers |
| 20.0 g | of dinotefuran |
| 109.8 g | of benzyl alcohol |
| 10.0 g | of water |
| 0.1 g | of citric acid |
| 0.1 g | of BHT (butylated hydroxytoluene) |
| 10.0 g | of Miglyol 812 |

### Example 8

A homogeneous spot-on solution comprising

| | |
|---|---|
| 52.5 g | of permethrin comprising 40% cis- and 60% trans-isomers |
| 20 g | of dinotefuran |
| 102.3 g | of N-methylpyrrolidone |
| 0.1 g | of citric acid |
| 0.1 g | of BHT |
| 25 g | of tetrahydrofurfuryl alcohol |
| 10 g | of Miglyol 812 |

### Example 9

A homogeneous spot-on solution comprising

| | |
|---|---|
| 45 g | of permethrin comprising 40% cis- and 60% trans-isomers |
| 20 g | of dinotefuran |
| 102.3 g | of 2-methylpyrrolidone |
| 0.1 g | of lactic acid |
| 0.1 g | of butylhydroxyanisole |
| 25 g | diethylene glycol monoethyl ether |

### Biological Examples

A. Activity Against Fleas on Dogs

Ctenocephalides felis

On days −4 and −1, dogs are infested with about 100 adult unfed Ctenocephalides felis per dog. The fleas are placed on the neck of the animal.

On day 0, the success of the infestation on the dog is examined by checking the awake animal for fleas. The number of live fleas is noted.

After the fleas have been counted, the animals are treated. The dogs of the control group are not treated. The medicaments to be examined according to Examples 1 to 18 are administered to the animals dermally as a spot-on in an application rate of 0.2 ml/kg of body weight. The application is carried out once on day 0. Only animals that are clinically healthy are used.

On day 1, all dogs are examined for live fleas. The results are noted with the crude data.

On days 7, 14, 21 and 28, all dogs are reinfested with about 100 adult unfed Ctenocephalides felis per dog. In each case one day after the reinfestation, all dogs are checked for live fleas. The results are noted with the crude data.

A formulation is considered to be highly active if, on day 1 and in each case on the second day after reinfestation, an efficacy of>95% is found, and this action persists for at least 3-4 weeks.

The efficacy is calculated using a modified formula according to Abbott:

$$Efficacy \% = \frac{∅ number of fleas - ∅ number of fleas TG}{∅ number of fleas CG} ⨯ 100$$

CG: Control group
TG: Treatment group

The medicaments of Formulation Examples 1 to 9, applied as a spot-on at a dosage of 0.2 ml/kg, were found to be highly effective against Ctenocephalides felis.

B. Efficacy Against Ticks (Rhipicefalus sanguineus) on Dogs

In each case on days −4 and −1, dogs are sedated using 2% Rompun® (Bayer AG, active compound: xylazine hydrochloride) (0.1 ml/kg of body weight). Once all dogs have been sedated (after about 10-15 minutes), they are transferred to transport boxes, and 50 Rhipicefalus sanguineus (25 ♀. 25 ♂) per dog are applied to the neck of the animal. After about 1½ hours, the animals are retransferred from the transport box into the cage.

On day 0, the success of the infestation on the dog is examined by checking the awake animal for ticks. An intensive search is carried out in the region of the head and the ears, including the folds of the ears, in the region of the neck, on the lower abdomen, on the lower breast, on the flank and in between the toes and the limbs. The number of sucking live ticks is noted. Dead ticks are removed.

After the ticks have been counted, the animals are treated. The dogs of the control group are not treated. The medicaments to be examined are administered to the animals dermally, as a spot-on. Application is carried out once on day 0. Only animals which are clinically healthy are used.

On day 1 and day 2, all dogs are checked for living and dead sucking ticks. The results are noted with the crude data. On day 2, all living and dead ticks are removed from the dog.

On days 7, 14, 21 and 28, all dogs are reinfested with in each case 50 Rhipicefalus sanguineus (25 ♀, 25 ♂) per dog. In each case one and two days after the reinfestation, all dogs are checked for living and dead sucking ticks. The results are noted with the crude data. On the second day after the reinfestation, all living and dead ticks are removed from the dog.

A formulation is considered to be highly active if, on day 2 and in each case on the second day after reinfestation, an efficacy of>90% is found, and this action persists for at least 3 weeks.

For calculating the efficacy, a modified formula according to Abbott is used:

$$Efficacy \% = \frac{∅ number of ticks CG - ∅ number of ticks TG}{∅ number of ticks CG} ⨯ 100$$

CG: Control group
TG: Treatment group

The medicaments according to Formulation Examples 1 to 9, applied as a spot-on at a dosage of 0.1 ml/kg, were found to be highly effective against Rhipicefalus sanguineus.

C. Activity Against Fleas and Ticks Over a Period of 6 Weeks

The activity of the compositions according to the invention against fleas and ticks was tested over a period of 6 weeks (Table 1). The test was carried out analogously to the description given under items A and B.

TABLE 1
Activity of the composition according to Example 6 against fleas and ticks

| | | Activity against | Activity against | Activity against | Activity against | Activity against | Activity against | Activity against |
|---|---|---|---|---|---|---|---|---|
| | | fleas (geo. | fleas (geo. | fleas (geo. | fleas (geo. | fleas (geo. | fleas (geo. | fleas (geo. |
| | | mean)/activity | mean)/activity | mean)/activity | mean)/activity | mean)/activity | mean)/activity | mean)/activity |
| | | against ticks | against ticks | against ticks | against ticks | against ticks | against ticks | against ticks |
| Number | Design of the study/ | (geo. mean) 1-2 | (geo. mean) 1 | (geo. mean) 2 | (geo. mean) 3 | (geo. mean) 4 | (geo. mean) 5 | (geo. mean) 6 |
| of the | application volume | days after | week after | weeks after | weeks after | weeks after | weeks after | weeks after |
| study | 0.1 ml/kg | treatment | treatment | treatment | treatment | treatment | treatment | treatment |
| 1 | Ctenocephalides | >95% | >95% | >95% | >95% | >95% | >90% | >90% |
| | felis | | | | | | | |
| | Rhipicephalus | >50% | >90% | >90% | >90% | >90% | >85% | >80% |
| | sanguineus | | | | | | | |
| 2 | Ctenocephalides | >95% | >95% | >95% | >95% | >95% | >90% | >90% |
| | felis | | | | | | | |
| | Dermacentor | >50% | >90% | >90% | >90% | >80% | >70% | >50% |
| | variabilis | | | | | | | |
| 3 | Ctenocephalides | >95% | >95% | >95% | >95% | >95% | >65% | |
| | felis | | | | | | | |
| | Rhipicephalus | >65% | >90% | >90% | >90% | >85% | >80% | |
| | sanguineus | | | | | | | |

The invention claimed is:

1. A composition of matter, comprising:
a) 0.1-60% by weight of an active pyrethroid compound;
b) 7.5-30.0% by weight of dinotefuran and/or dinotefuran analogues;
c) 27.5-62.5% by weight of organic solvents from the class of the methylpyrrolidones, aliphatic alcohols and cyclic carbonates, aliphatic, cyclic or acyclic ethers and mixtures of these;
d) 0-5% by weight of water;
e) 0-0.5% by weight of phenolic antioxidants; and
g) 0-0.5% by weight of organic acids.

2. A composition according to claim 1, wherein the active pyrethroid compound is permethrin.

3. A composition according to claim 1, wherein the active pyrethroid compound is α-cyanopyrethroid.

4. A composition according to claim 1, wherein the active pyrethroid compound is flumethrin.

5. A composition according to claim 1, wherein component b) is dinotefuran.

6. A method of controlling parasitic arthropods on animals comprising administering to an animal an effective amount of the composition according to claim 1.
